(19) United States
(12) Patent Application Publication
(10) Pub. No.: US 2024/0353666 A1
(43) Pub. Date: Oct. 24, 2024

(54) BIOCOMPATIBLE OPTICAL SLIDE INTENDED FOR TOTAL INTERNAL REFLECTION MICROSCOPY AND MICROSCOPY IMAGING SYSTEM INCLUDING SUCH A SLIDE

(71) Applicants: CENTRE NATIONAL DE LA RECHERCHE SCIENTIFIQUE, Paris (FR); UNIVERSITE D'AIX MARSEILLE, MARSEILLE (FR); ECOLE CENTRALE DE MARSEILLE, MARSEILLE (FR); UNIVERSITE DE MONTPELLIER, MONTPELLIER (FR)

(72) Inventors: Anita MOUTTOU, BOBIGNY (FR); Julien LUMEAU, MARSEILLE (FR); Aude LEREU, MARSEILLE (FR); Cyril FAVARD, CASTELNAU-LE-LEZ (FR)

(21) Appl. No.: 18/685,292

(22) PCT Filed: Aug. 24, 2022
(86) PCT No.: PCT/EP2022/073565

§ 371 Date: Feb. 21, 2024

(30) Foreign Application Priority Data
Aug. 24, 2021 (FR) FR2108879

(51) Int. Cl. G02B 21/16; G02B 5/26; G02B 21/08; G02B 21/34; G02B 27/56

(52) U.S. Cl. CPC G02B 21/16; G02B 5/265; G02B 21/082; G02B 21/34; G02B 27/56

(57) ABSTRACT

An optical slide intended to receive a biological sample for the purposes of total internal reflection microscopy. Such an optical slide includes a glass base substrate and a stack of thin layers of alternating dielectric materials which is arranged on the substrate, the free layer of the stack being biocompatible. The stack has index and layer thickness characteristics for supporting the surface waves at the interface between the free layer and the sample, such that the imaging sensitivity and resolution of total internal reflection microscopy are improved.

### TECHNICAL FIELD

The invention belongs to the field of optical microscopy. More particularly, the invention relates to a novel concept of optical slide based on a multilayer stack as support for enhancing the electromagnetic field adapted to total internal reflection microscopy.

The invention particularly, but not exclusively, applies to the field of biological sample imaging by Total Internal Reflection Fluorescence or TIRF microscopy. Such an imaging technique is particularly well adapted to the visualisation, analysis and quantification of molecular events that are carried out particularly at the plasma membrane of biological cells.

### TECHNOLOGICAL BACKGROUND

More particularly, it is endeavoured to describe in the remainder of this document the problem existing in the field of total internal reflection fluorescence microscopy imaging, with which the inventors of the present invention have been confronted. Of course, the invention is not limited to this particular context of application but is of interest for any microscopy modality or technique using the total internal reflection imaging principle.

Total internal reflection fluorescence (TIRF) microscopy has become a benchmark technique for studying the dynamics and membrane organisation in biological cells. One of its advantages lies in the possibility of confining the excitation light in an ultra-thin section of the sample located at the interface between the sample and the glass microscope slide so that a selective excitation of the sample can be performed. Thus, such a technique makes the feasibility of images of single molecules on the nanometric scale possible.

The TIRF technique is based on the following principle. The biological sample that is arranged on the microscope slide (for example a glass substrate) is illuminated through the microscope slide using a laser excitation beam. When the excitation beam hits the interface between the glass slide and the sample under an angle of incidence greater than or equal to the critical angle of total internal reflection, one of the electromagnetic components of the light, called evanescent wave, propagates to said interface in an ultra-thin section of the sample, with a light intensity that decreases exponentially with the distance to said interface. The penetration depth of the evanescent field is typically less than 100 nm. The resulting fluorescence signal—in other words the electromagnetic waves emitted by the observed fluorescent molecules—is subsequently collected towards a light detector for the purposes of imaging.

Thus, through this known technique, the images obtained have multiple qualities: firstly, they benefit from a low background noise (because the fluorophores located in the deep layers of the sample (outside of the evanescent field) are only very slightly excited) and from a relatively high axial resolution.

Microscope slides with more complex structures, such as those based on a surface metallisation have moreover been designed to locally enhance the electromagnetic field. Such optical slides, which are based on the surface plasmon resonance principle, make it possible to improve the sensitivity of the microscopy imaging. However, this known solution remains limited in terms of field enhancement value and in the selection of materials, i.e. noble metals, which limit the illumination conditions that can be used as well as the biocompatibility, which is not optimal.

Another known technique, described in the patent document US 2016/0238830, is based on a multilayer wave guide, the layer thicknesses and refractive indices of which are selected to withstand a guided leak mode. Yet, the microscopy imaging experiments carried out with this technique also remain limited particularly from the sensitivity and resolution point of view.

Consequently, there is a need to provide a high-resolution microscopy technique that is able to image biological samples under illumination conditions that are stable and reproducible with an improved signal to noise ratio.

### DISCLOSURE OF THE INVENTION

In a particular embodiment of the invention, it is proposed an optical slide intended to receive a biological sample for the purposes of total internal reflection microscopy imaging, the optical slide comprising an optically transparent base substrate and a stack of layers of dielectric materials. The stack is such that it is arranged directly on the base substrate and formed of a succession of pairs of alternating thin layers of a first dielectric material of high refractive index and of a second dielectric material of low refractive index capable of producing an optical resonance at a predetermined angle of incidence and illumination wavelength of the optical slide in total reflection mode.

Thus, the invention is based on a novel design of an optical slide for performing total internal reflection microscopy. Such a stack of dielectric multilayers coupled with the base substrate makes it possible to ensure a significant enhancement of the evanescent electromagnetic field propagating at the interface between the slide and the sample at the contact layer. This kind of “dielectric resonance” is therefore designed to amplify by optical resonance the light intensity of the evanescent waves confined at the surface of the optical slide in contact with the sample. Thanks to this approach, the sensitivity of the microscopy imaging as well as the spatial resolution is improved. In addition it appears, compared to existing plasmon resonance slides, that this proposed type of optical slide can be easier to use because it adapts to a wider range of TIR microscopy imaging parameters.

According to a particular feature, the layer of said stack intended to be in contact with the sample (referred to as end or contact layer), is based on a third biocompatible dielectric material having an absorption coefficient between 1×10⁻⁸ and 1×10⁻². This range of values makes an optimal operation of the slide possible. Indeed, the inventors discovered that the absorption coefficient of the end layer is a key parameter for controlling the amplitude of the evanescent electromagnetic field at the interface with the sample.

According to a particular implementation, the first dielectric material has a high refractive index between 1.8 and 3.5 and the second dielectric material has a low refractive index between 1.2 and 1.7. The third material, for its part has a low or high refractive index according to the refractive index of the thin layer preceding the end layer (in order to respect the alternating indices of the stack). Thus, the invention offers a relatively wide choice of refractive indices that can be used to design the dielectric resonator.

More particularly, the thin layers each have a thickness that depends on the illumination wavelength, on the angle of incidence and on the refractive index of the material for which it is formed. Thus, it is possible to easily design an optical slide regardless of the imaging parameters imposed by the TIR microscopy system.

According to a particular implementation, the optically transparent substrate is based on a material belonging to the following group: soda-lime glass, sapphire, quartz, calcium fluoride.

According to a particular implementation, the first dielectric material is based on Nb₂O₅ and the second dielectric material is based on SiO₂ and the third dielectric material is based on SiO₂ or SiOₓ.

In general, in accordance with the invention, the thickness of each thin layer is between 1 and 300 nanometres, and more particularly between 75 and 150 nanometres, whereas the thickness of the base substrate is between 50 and 2,000 micrometres. The stack has a total thickness less than 10 micrometres, and more particularly between 0.2 and 4.0 micrometres. The stack comprises a number of thin layers typically between 4 and 20.

In another embodiment of the invention, a total internal reflection microscopy system is proposed, comprising:
an optical slide defined in any one of the aforementioned embodiments thereof;
a light source configured to emit a light beam;
a microscope lens configured to form the light beam towards the optical slide;
   the microscope lens and slide being configured so that the angle of incidence is greater than or equal to a critical angle of total internal reflection.

It is reminded that the angle of incidence corresponds to the angle between the axis of the light beam and the stack axis of the optical slide. It should be noted that, the closer the selected angles of incident are to the upper limit of the aforementioned range, the greater the axial resolution of the system is increased.

According to an advantageous feature, the angle of incidence is less than or equal to a limit value defined by the numerical aperture of the microscope lens. More specifically, the angle of incidence is between 62 and 80 degrees.

In another embodiment of the invention, it is proposed a method for manufacturing an optical slide intended to receive a biological sample for the purposes of total internal reflection microscopy imaging. The method is such that it comprises:
a step of depositing on an optically transparent base substrate a plurality of alternating and successive thin layers of a first dielectric material and of a second dielectric material so as to form a dielectric multilayer stack capable of producing an optical resonance at a predetermined angle of incidence and illumination wavelength of the optical slide in total reflection mode, the layer of said stack intended to be in contact with the sample being based on a biocompatible dielectric material.

Thus, it is possible to design an optical slide with enhancement of the electromagnetic field that can be configured regardless of the imaging parameters imposed by the microscopy system.

### LIST OF FIGURES

Other features and advantages of the invention will become apparent upon reading the following description, given by way of illustrative and non-limiting example, and the appended drawings, wherein:

FIG. 1 is a simplified diagram of a total internal reflection microscopy system according to a particular embodiment of the invention;

FIG. 2 shows a first example of optical slide according to the invention that can be used in the imaging system of FIG. 1;

FIG. 3 shows a second example of optical slide according to the invention that can be used in the imaging system of FIG. 1.

### DETAILED DESCRIPTION OF THE INVENTION

In all the figures of the present document, the identical elements and steps are designated by the same numerical reference.

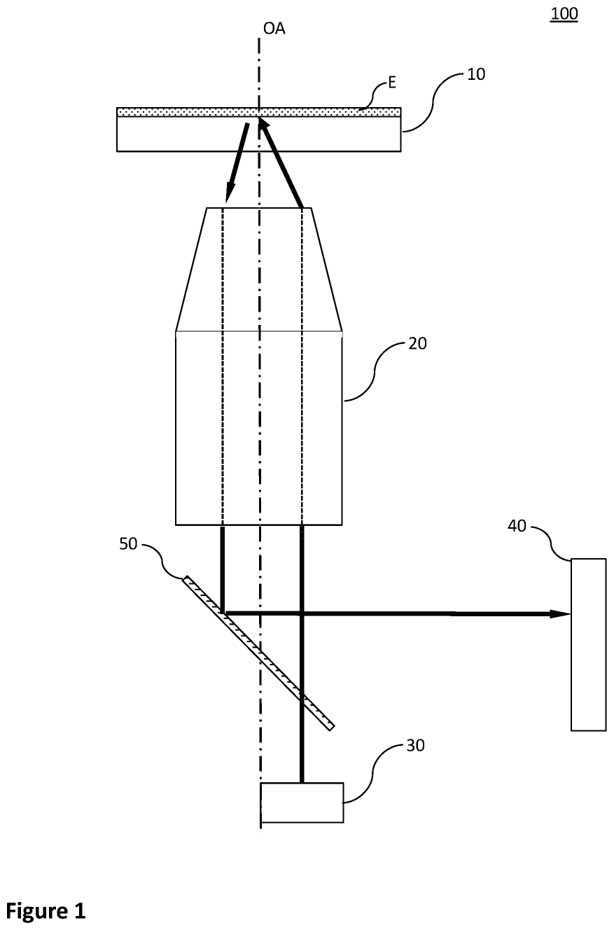

FIG. 1 shows in a simplified manner a total internal reflection microscopy system 100, according to a particular embodiment of the invention. Such a system comprises an optical slide 10, a microscope lens 20, a light source 30 and a light detector 40.

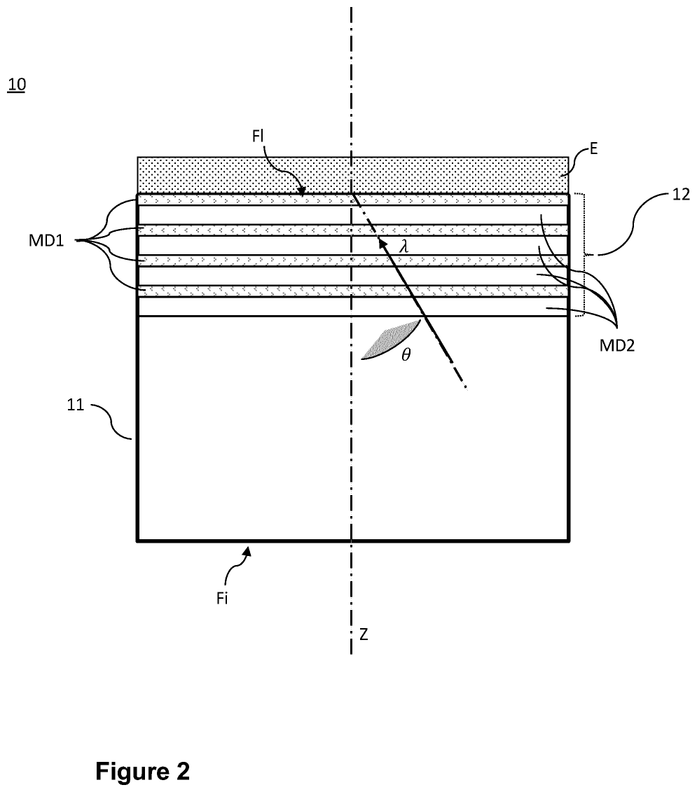

The optical slide 10 is a biocompatible slide intended to receive a biological sample E for the purposes of microscopy imaging according to a total internal reflection configuration. One example of optical slide structure in accordance with the invention is described further in relation with FIG. 2.

The microscope lens 20 is a lens with a wide aperture, typically greater than or equal to 1.45. It comprises a lens or a more or less complex set of optical lenses capable of making it possible to form the light beam in the direction of the optical slide and collect the beam reflected and/or backscattered from the optical slide along an optical axis OA. The microscope lens 20 may have a variable focus and variable numerical aperture (greater than 1.45).

The light source 30 is a laser source configured to emit a laser light beam of predetermined wavelength λ (typically equal to 561 nm, but more generally between 350 and 1,300 nm), capable of exciting the molecules contained in the sample.

The light detector 40 is a CCD or CMOS camera the spectral band of which is adapted to detect light by fluorescence re-emitted from the sample (this light by fluorescence being at a wavelength different from the excitation wavelength λ). It converts the light intensity received into an electrical signal to a processing unit (not shown in the figures). The processing unit is electrically connected to the light source 30, to the light detector 40 and to the microscope lens 20 so as to be able to control these elements for the purposes of acquiring images of the sample E in total internal reflection mode.

The microscopy system 100 shown here is based on the epifluorescence principle of which the observation of the fluorescence is carried out in a reflection configuration by means of a slide or of a dichroic mirror 50 for example. This particular configuration makes it possible to dissociate the optical path taken by the excitation light, from the optical path taken by the reflected and/or backscattered light. It is endeavoured to describe hereinafter with more detail the structure of the optical slide according to the invention, such as shown in FIG. 2.

The optical slide 10 has a first face, referred to as free face FI, and a second face, opposite the first, referred to as incidence face Fi, and defines a stack axis Z extending between these two opposite faces. The free face FI is intended to receive the biological sample E to be observed and the incidence face Fi is the incidence face of the illumination light. FI forms the free interface where an enhancement of the electromagnetic field can be supported by the optical slide 10.

In this particular embodiment, the optical slide 10 and the microscope lens 20 are arranged so that the stack axis Z of the slide coincides with the optical axis OA. In other words, the optical slide 10 and the microscope lens 20 are orientated in relation to one another in such a way that the optical interface formed between the optical slide 10 and the sample E are perpendicular to the optical axis OA. The microscope lens 20 is configured so that the angle of incidence θ of the light beam (defined between the axis of the light beam and the stack axis Z), is greater than or equal to the critical angle of total internal reflection, typically an angle of incidence between 62 and 80 degrees for a biological environment of refractive index between 1.33 and 1.35.

According to the invention, the optical slide 10 comprises a base substrate made of optically transparent material 11, such as for example a microscope slide made of soda-lime glass of index 1.5 (or any other optically transparent support calibrated in thickness), whereon a stack of thin dielectric layers 12 is arranged that is used to support the enhancement of the electromagnetic field in total internal reflection mode. As illustrated in FIG. 2, this stack 12 is formed of a succession of a plurality of alternating thin layers of a first dielectric material with high refractive index (thin layers referenced MD1) and of a second dielectric material with low refractive index (thin layers referenced MD2). In the example of embodiment illustrated here, the stack is globally in planar form of eight thin layers covering all or part of the base substrate 11.

In addition, in this example, the dielectric material MD1 retained is based on Nb₂O₅ and the dielectric material MD2 is based on SiO₂.

The thin layer intended to be in contact with the sample E, referred to as free layer CL, is based on a biocompatible dielectric material, such as based on Nb₂O₅ as in the example illustrated here, or typically based on SiO₂. The upper face of this free layer CL corresponding to said free face FI discussed above. As for the incidence face Fi, it corresponds to the lower face of the base substrate 11.

The thickness of the thin layers MD1 and MD2 is selected depending on the illumination wavelength λ, on the angle of incidence of light beam and on the refractive index of the material of which it is formed. The thickness of the thin layers is generally between 1 and 300 nanometres. The thickness of the base substrate 11 is between 50 and 2,000 micrometres and the total thickness of the dielectric stack 12 is generally less than 10 micrometres. The total thickness of the dielectric stack 12 is preferably between 0.2 and 4 micrometres.

It should be noted that the thickness, the number and the nature of the thin layers of said stack may be adapted on a case-by-case basis, depending particularly on the imaging conditions of the system, such as the illumination wavelength λ and the angle of incidence θ.

For example, for a wavelength of 561 nm, an angle of incidence of 68 degrees and a numerical aperture of 1.49, a stack of 8 alternating and successive thin layers of refractive indices 2.25 and 1.46 and of total thickness 842 nm, has demonstrated good performances from the sensitivity and spatial resolution point of view.

More generally, a number of thin layers between 4 and 20 may be envisaged without departing from the scope of the invention. The number of thin dielectric layers is selected depending on the targeted application, the nature of the materials, the illumination conditions imposed by the microscopy system used and the desired field enhancement factor.

When the microscopy system 100 is in operation, the biological sample E that is arranged on the free layer CL is illuminated through the optical slide using the wavelength light beam λ. More specifically, the light beam passes through the base substrate 11, then the dielectric stack 12 until it reaches the interface between the free layer CL and the sample E under the angle of incidence θ to meet the total internal reflection imaging conditions. The evanescent wave created by the base substrate 11 and that propagates to said interface sees its light intensity amplified thanks to the dielectric stack 12. Indeed, the inventors observed that the presence of such a multilayer structure affixed directly on a glass substrate induces, by optical resonance, an enhancement of the evanescent electromagnetic field at the surface of said optical slide (that is to say the free interface FI), making it possible to significantly increase the TIRF microscopy imaging performances, in particular in terms of sensitivity and of spatial resolution.

The fluorescence light from the sample E is subsequently captured by the light detector 40 via the dichroic mirror 50, then processed for the purposes of imaging.

In addition, it should be noted that the closer the angle of incidence value θ selected is to the upper limit of the aforementioned range (80 degrees for a numerical aperture at 1.49), the more the axial resolution of the system is increased (the evanescent field depth reducing). The value of the angle of incidence θ may therefore be optimised depending on the desired performances and constraints imposed by the system. The lower limit of the aforementioned range (62 degrees) is given by the refractive index value of the sample of interest. As for the upper limit of the aforementioned range (80 degrees), it is defined depending on the value of the numerical aperture used for the microscopy observation.

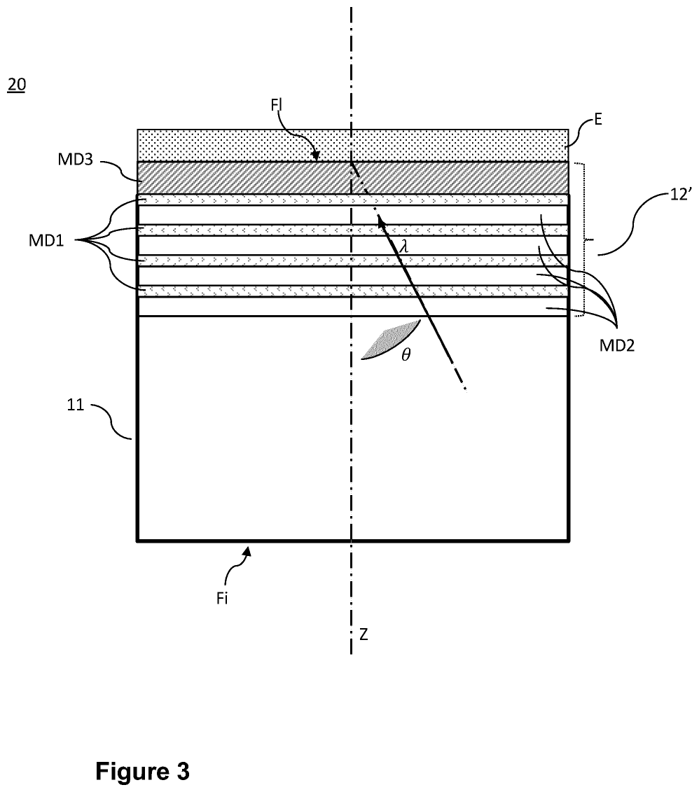

It is endeavoured to describe hereinafter a second example of optical slide 20 according to the invention, such as shown in FIG. 3. As opposed to the slide structure illustrated in FIG. 2, the stack end layer 12′ intended to be in contact with the sample E is based on a biocompatible dielectric material MD3 having a characteristic complex refractive index, the value of the imaginary part of which is selected to maximise the light intensity of the evanescent field at the slide/sample interface. This complex refractive index (n) comprises a real part with low index (n′ between 1.2 and 1.7 to continue the index contrast in the stack) and an imaginary part, also called absorption coefficient (k), such that: n=n′+k×i. Typically, the end layer MD3 is based on silicon dioxide SiO₂ of complex index n_{SiO2}=n_{Sio2′}+10⁻⁵ ×i or based on silicon oxide SiOₓ (partially oxidised silica) of complex index n_{SiOx}=1.602+3.2×10⁻³×i.

More generally, the value of the absorption coefficient is between 1×10⁻⁸ and 1×10⁻², the principle being to give preference to the lowest possible absorption coefficient for the end layer. Such an approach makes it possible, by playing on the absorption of the end layer, to control the amplitude of the evanescent field, and therefore the intensity of the fluorescence signal arriving on the detector (and thus to improve the TIRF microscopy imaging performances).

The main steps of the method for manufacturing an optical slide are described hereinafter according to a particular embodiment of the invention. The method consists in carrying out the deposition, on a glass substrate plate, such as a microscopy slide, for example, of a plurality of alternating and successive thin layers of a first dielectric material and of a second dielectric material so as to form a multilayer dielectric stack (such as the dielectric stack 12 for example).

It is reminded that the nature, the thickness and the number of thin layers for each of the two dielectric materials are determined beforehand so that the resonator thus obtained is able to support a surface optical resonance mode (according to the abovementioned principle) at the illumination wavelength λ and the angle of incidence θ in total internal reflection mode.

The deposition of each thin layer is performed by means of one of the following techniques (without being exhaustive): vacuum evaporation, vacuum sputtering, sol-gel method, spin coating, chemical vapour deposition, plasma deposition.

Thus, the invention offers the possibility of producing optical slides with electromagnetic field enhancement the features of which may be easily adapted depending on the imaging parameters required by the microscopy system.

As indicated above, the thickness, the number and the material type are features of the stack according to the invention that may be adapted on a case-by-case basis, particularly depending on the imaging parameters of the system and the desired or imposed lighting conditions. Preference will be given to optically transparent materials within the spectral band used to conduct the study, of which the dispersion values of the refractive index and of the absorption coefficient are known and controlled. Such features must make it possible, at a predetermined angle of incidence and illumination wavelength of the optical slide in total reflection mode, an optical absorption in the free layer of the stack enhancing the evanescent electromagnetic field at the free interface of the stack.

1. An optical slide to receive a biological sample for the purpose of total internal reflection microscopy imaging, the optical slide comprising:
an optically transparent base substrate; and
a stack of layers of dielectric materials, wherein said stack is arranged directly on the base substrate and formed of a succession of pairs of alternating thin layers of a first dielectric material of high refractive index and of a second dielectric material of low refractive index capable of producing an optical resonance at a predetermined angle of incidence and illumination wavelength of the optical slide in total reflection mode.

2. The optical slide according to claim 1, wherein:
the first dielectric material has a high refractive index between 1.8 and 3.5;
the second dielectric material has a low refractive index between 1.2 and 1.7.

3. The optical slide according to claim 1, wherein the layer of said stack positioned to be in contact with the sample is based on a third biocompatible dielectric material having an absorption coefficient between 1×10⁻⁸ and 1×10⁻².

4. The optical slide according to claim 3, wherein the first dielectric material is based on Nb₂O₅, the dielectric second material is based on SiO₂ and the third biocompatible dielectric material is based on SiO₂ or SiOₓ.

5. The optical slide according to claim 1, wherein said stack has a total thickness less than 10 micrometres.

6. The optical slide according to claim 1, wherein said stack comprises a number of thin layers typically between 4 and 20.

7. A total internal reflection microscopy system comprising:
an optical slide comprising:
an optically transparent base substrate; and
a stack of layers of dielectric materials, wherein said stack is arranged directly on the base substrate and formed of a succession of pairs of alternating thin layers of a first dielectric material of high refractive index and of a second dielectric material of low refractive index capable of producing an optical resonance at a predetermined angle of incidence and illumination wavelength of the optical slide in total reflection mode;
a light source configured to emit a light beam; and
a microscope lens configured to form the light beam towards the optical slide;
wherein the optical slide and the microscope lens are configured so that the angle of incidence is:
greater than or equal to a critical angle of total internal reflection, and less than or equal to a limit value defined depending on the numerical aperture of the microscope lens.

8. The total internal reflection microscopy system according to claim 7, wherein the angle of incidence is between 62 and 80 degrees.

9. The total internal reflection microscopy system according to claim 7, wherein the microscope lens has a numerical aperture typically greater than or equal to 1.45.

10. The total internal reflection microscopy system according to according to claim 7, wherein the microscope lens has a variable numerical aperture.

11. The total internal reflection microscopy system according to claim 1, wherein the microscope lens has a variable focus.

12. A method for manufacturing an optical slide to receive a biological sample for the purpose of total internal reflection microscopy imaging, wherein the method comprises:
depositing on an optically transparent base substrate a plurality of alternating and successive thin layers of a first dielectric material and of a second dielectric material so as to form a dielectric multilayer stack capable of producing an optical resonance at a predetermined angle of incidence and illumination wavelength of the optical slide in total reflection mode.

13. The optical slide according to claim 5, wherein the total thickness is between 0.2 and 4.0 micrometres.
